(19) United States
(12) Patent Application Publication
(10) Pub. No.: US 2009/0195541 A1
(43) Pub. Date: Aug. 6, 2009

(54) RENDERING DYNAMIC OBJECTS USING GEOMETRY LEVEL-OF-DETAIL IN A GRAPHICS PROCESSING UNIT

(75) Inventors: Liang Peng, San Jose, CA (US); Yixhou Yu, Champaign, IL (US); Wei-Wen Feng, Urbana, IL (US)

Correspondence Address: PVF -- RAMBUS, INC.;c/o PARK, VAUGHAN & FLEMING, LLP, 2820 FIFTH STREET, DAVIS, CA, 95618-7759, US

(73) Assignee: RAMBUS INC., Los Altos, CA (US)

(21) Appl. No.: 12/362,122

(22) Filed: Jan. 29, 2009

Related U.S. Application Data
(60) Provisional application No. 61/026,373, filed on Feb. 5, 2008.

(51) Int. Cl. G06T 17/00

(52) U.S. Cl. 345/420

(57) ABSTRACT

The present embodiments provide a system for graphically rendering an object. This system operates first by pre-processing a geometry mesh for the object offline, wherein the geometry mesh is partitioned into a set of patches, and wherein each patch is bounded by a bounding box. The system then builds a multi-resolution representation for each of the set of patches. Next, during real time rendering, the system deforms the bounding boxes associated with the set of patches through superposition of object motions in each frame weighted by a set of predetermined mesh-skinning parameters. For each deformed bounding box, the system computes a geometry level-of-detail (LOD) value based on a projected area of the deformed bounding box in screen space. The system next deforms the object through a set of mesh skinning operations. The system then renders the deformed object based on the computed geometry LOD values for the set of patches and the multi-resolution representation for the geometry mesh.

### RELATED APPLICATION

This application hereby claims priority under 35 U.S.C. §119 to U.S. Provisional Patent Application No. 61/026,373, filed on 5 Feb. 2008, entitled “RENDERING DYNAMIC OBJECTS USING GEOMETRY LEVEL-OF-DETAIL IN A GRAPHICS PROCESSING UNIT”, by inventor(s) Liang Peng, Yizhou Yu and Wei-Wen Feng (Docket No. R-RA0595.Prov1.US).

### TECHNICAL FIELD

The present embodiments generally relate to computer graphics. More specifically, the present embodiments relate to a method and an apparatus for efficiently rendering dynamic objects using a geometry level-of-detail (LOD) representation with a Graphics Processing Unit (GPU).

### BRIEF DESCRIPTION OF THE FIGURES

FIG. 1 illustrates a computer system.

FIG. 2 illustrates a high-level architecture of a typical GPU rendering pipeline.

FIG. 3 presents a flowchart illustrating a process that builds an LOD representation for an input object prior to performing a dynamic rendering operation on the object.

FIG. 4 presents a flowchart illustrating the process of computing real-time LOD values for a dynamic object when the object is being deformed.

FIG. 5 presents a flowchart illustrating the process of rendering a dynamic object based on the computed LOD values.

FIG. 6 illustrates an LOD-based rendering operation which uses a CPU to control the rendering process.

FIG. 7 illustrates an LOD-based rendering operation which uses a geometry shader to directly control the rendering operation.

FIG. 8 presents code written for the geometry shader to directly control the rendering operation.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present description. Thus, the present description is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer readable media now known or later developed.

### Overview

For a given GPU-based graphics rendering system, the amount of geometric complexity associated with a real-time application is generally limited by the processing and memory bandwidth resources available to the GPU system. Moreover, it can be extremely wasteful of these resources if every polygon in an object must be loaded from the memory and processed by the GPU during a rendering operation, because most of these polygons are invisible when the object is ultimately projected into a two-dimensional (2D) screen space to form an image for display. Note that the finest level of detail for a geometrical primitive is typically determined by the size of the projected geometry relative to the pixel size in the projected image. Hence, in many cases, simplified geometry models for objects are sufficient to produce the same rendering quality as the original geometry models. Meanwhile, the reduced geometric complexity associated with these simplified geometry models significantly reduces the runtime processing and bandwidth requirements for the GPU, and thereby improving the rendering performance dramatically.

A level-of-detail (LOD) technique in computer graphics involves building and storing a geometrical representation of objects at multiple resolutions in memory or disk prior to the graphics rendering operation, such that only the appropriate subset of the representation are adaptively selected and used in rendering operation at real time. When a level-of-detail (LOD) representation is used during rendering operation, typically only a small portion and simplified version of the entire geometrical dataset is fetched and used by the GPU, at the expense of the total storage requirement being increased by a factor of two. In general, the use of the LOD representation of objects can significantly improve system performance for rendering complex objects in real-time applications by balancing required visual fidelity with available hardware resources.

One technique to build an LOD representation for an object is to generate multiple resolution levels from an arbitrary irregular mesh. In some embodiments, this type of multi-resolution representation can be built using a technique referred to as a “multi-chart based geometry image (GI) technique” (see “Multi-chart geometry images,” by P. Sander, Z. Wood, S. Gortler, J. Snyder, H. Hoppe, in Symposium on Geometry Processing 2003, pp. 146-155). In this technique, an input triangular mesh is segmented into a number of “charts” or “patches” in a preprocessing stage, wherein each chart or patch is topologically disk-flat and can be mapped to a two dimensional rectangular image. The image is then recursively down-sampled with a user-specified filter to form a pyramid of image mid-maps, wherein each mid-map is associated with a unique geometry LOD value. At runtime, the multi-chart geometry image representation of the object is used adaptively on-the-fly based on the geometry LOD value for each chart. For example, vertices at the appropriate geometry LOD can be loaded from memory and assembled to form triangles which can be processed in later rendering stages within a rendering pipeline.

However, existing geometry multi-resolution techniques are primarily performed through software in a CPU-based rendering system, or in a hardware-based DirectX 9 GPU system where generic geometry operations are not directly supported by the GPU. Moreover, these techniques are typically only applied to static objects (i.e., non-deformable objects), where static multi-resolution geometry datasets are preprocessed, stored and used. However, deformation or temporal coherence is not allowed in those techniques. Hence, these existing techniques are not applicable to deformable objects and associated meshes (we referred to these deformable objects as “dynamic objects” hereafter). Meanwhile, dynamic objects are increasingly used in interactive games and various digital content designs that provide real-time or interactive performance. Unfortunately, there is little known about applying the general LOD technique to these dynamic objects. Some difficulties for extending the LOD technique to dynamic objects include: determining how to accurately represent a deformable geometry with a multi-resolution data structure, and determining how to store this data structure in memory for later use by the GPU during a rendering pass.

Note that deformable meshes for dynamic objects may be generated using a number of different techniques, which can include, but are not limited to: cloth simulation, elastic material simulation, and fluid simulation. However, most of these techniques are computationally expensive and hence, it is difficult to achieve real-time performance. An alternative strategy is to first generate a number of “examples” using above-mentioned techniques off-line, and to either directly play back these examples or use these examples to train a simpler mesh-deformation model for interactive manipulation. In the direct-playback case, researchers have generalized static multi-resolution representations to mesh sequences. However, it is still unclear how to simplify the meshes so that adjacent frames maintain temporal coherence because directly applying static multi-resolution techniques to each individual frame can cause problem with serious “pop-in/out” visual artifacts. Note that when deformation of a surface mesh is controlled by a few underlying rigid “bones,” (e.g., the skeletal structures of humans or animals), a simple mesh skinning model can be used to perform the deformation. This technique generally requires a predefined skeleton. However, when the skeleton is not given, it is possible to determine the skeleton by deforming meshes using a segmentation technique.

Embodiments of this disclosure facilitate applying geometry multi-resolution techniques to dynamic objects associated with deforming or deformable mesh. Specifically, for an input deformable mesh, the system partitions the mesh into a set of patches. The system subsequently builds a multi-resolution representation for each of the patches, wherein each multi-resolution representation comprises a pyramid of LOD geometry images for a given patch. The system then deforms the input mesh, and computes geometry LOD values for each deformed patch. Note that the geometry LOD values computed for the deformed patches can include an integer part and fractional part. Next, the system renders each deformed patch based on associated LOD values as well as the precomputed multi-resolution representation for the original patch.

### Computer System

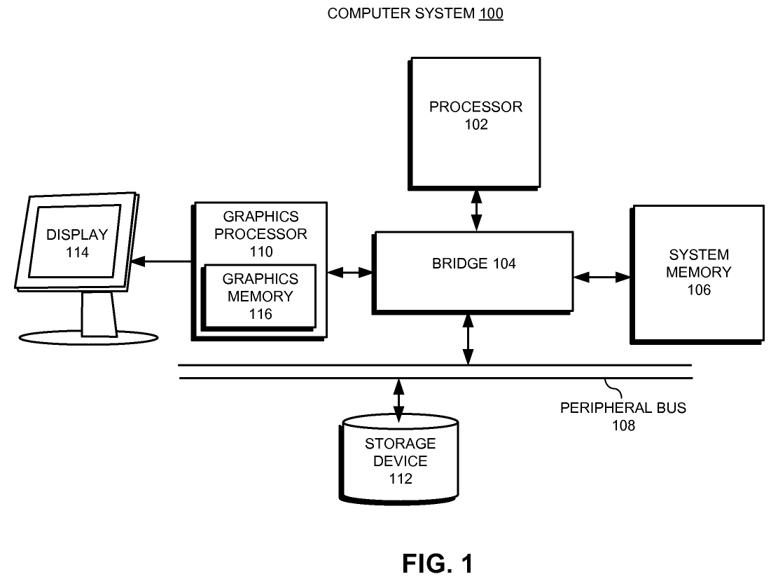

FIG. 1 illustrates a computer system 100. As illustrated in FIG. 1, computer system 100 includes processor 102, which is coupled to system memory 106, peripheral bus 108, and graphics processor 110 through bridge 104. Bridge 104 can include any type of core logic unit, bridge chip, or chipsets that are commonly used to couple together components within computing system 100. In some embodiments, bridge 104 is a northbridge chip. It should be recognized that one or more components of the computer system 100 may be located remotely and accessed via a network.

Processor 102 can include any type of processor, including, but not limited to, a microprocessor, a digital signal processor, a personal organizer, a device controller and a computational engine within an appliance, and any other processor now known or later developed. Furthermore, processor 102 can include one or more cores. Processor 102 includes a cache that stores code and data for execution by processor 102. In some embodiments, processor 102 is a central processing unit (CPU).

Processor 102 communicates with system memory 106 through bridge 104. System memory 106 can include any type of memory that can store code and data for execution by processor 102 at high speed. This includes, but is not limited to, dynamic random access memory (DRAM), static random access memory (SRAM), flash memory, read-only memory (ROM), and any other type of memory now known or later developed. Note that system memory 106 is typically referred to as the “main memory” of computer system 100.

Processor 102 also communicates with storage device 112 through bridge 104 and peripheral bus 108. Storage device 112 can include any type of non-volatile storage device that can be coupled to a computer system. This includes, but is not limited to, magnetic, optical, and magneto-optical storage devices, as well as storage devices based on flash memory and/or battery-backed up memory.

Processor 102 additionally communicates with graphics processor 110 through bridge 104. Graphics processor 110 is a specialized graphics rendering device that provides a signal source to display 114 and drives display 114. Display 114 can include any type of display device that can present information in a visual format (including images and text) to a user. This includes, but is not limited to, a cathode ray tube (CRT) display, a light-emitting diode (LED) display, a liquid-crystal display (LCD), an organic LED (OLED) display, a surface-conduction electron-emitter display (SED), or electronic paper.

Graphics processor 110 performs both 2D and 3D graphics rendering operations, such as lighting, shading, transforming, with higher performance than if these operations are performed by processor 102 directly. To achieve this high performance, graphics processor 110 may utilize dedicated video/graphics memory 116 which is embedded on or packaged with graphics processor 110 to store frame buffers, textures, vertex arrays, and/or display lists. In some embodiments, graphics processor 110 is a graphics processing unit (GPU).

Note that although the disclosure is described in the context of computer system 100 illustrated in FIG. 1, the proposed techniques can generally operate on any type of computing device that supports one or more graphics processors. For example, the proposed techniques can operate on a computer system having a unified memory architecture (UMA). In such a computer system, a GPU does not include a dedicated graphics memory, but shares a system memory with the CPU. Hence, the disclosure is not limited to computer system 100 illustrated in FIG. 1.

### GPU Rendering Pipeline

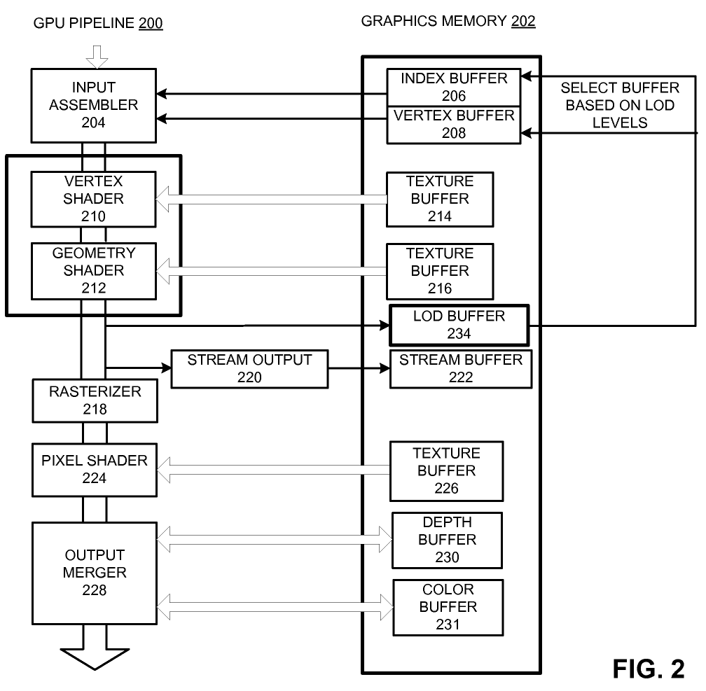

FIG. 2 illustrates the high-level architecture of a typical GPU rendering pipeline 200.

More specifically, GPU pipeline 200 comprises a sequence of graphics functional modules, which are shown on the left hand side of FIG. 2. Note that these GPU functional modules can receive input data from and can store output data to graphics memory 202, which is shown on the right hand side of FIG. 2.

More specifically, GPU pipeline 200 includes an input assembler 204, which can receive geometry data from index buffer 206 and vertex buffer 208 in graphics memory 202, and can form primitive geometries (e.g., triangles) based on the received geometry data. We describe index buffer 206 and vertex buffer 208 in more detail below. Note that input assembler 204 can also receive GPU commands through an Application Programming Interface (API) of the GPU.

Next, the output primitive geometries (or “primitives” hereafter) from input assembler 204 are fed into vertex shader 210 and geometry shader 212 sequentially. Vertex shader 210 performs mathematical operations, such as transformations, skinning or lighting, on individual vertices of the input primitives. In contrast, geometry shader 212 processes entire input primitives (e.g., triangles, lines or pixels) and, sometimes, their edge-adjacent primitives. In doing so, for each input primitive, geometry shader 212 can: modify the primitive (e.g., by adding or removing one or more vertices); discard the primitive (e.g., by culling); or generate one or more new primitives based on the input primitive. Note that both vertex shader 210 and geometry shader 212 can also fetch texture information from respective texture buffers 214 and 216 located in graphics memory 202, and can add shading effects to the geometries being processed. In one embodiment, texture buffer 214 and texture buffer 216 are merged into a single texture buffer.

As shown in FIG. 2, the output primitives from geometry shader 212 further move down the pipeline into rasterizer 218, which is configured to break up the input primitives into pixels. Note that rasterizer 218 can also perform clipping and culling operations to remove vertices that will not be visible on the display. Note that the output primitives from geometry shader 212 can also be exported from the pipeline through stream output 220 and stored into stream buffer 222 in graphics memory 202. In one embodiment of the present invention, the primitives stored in stream buffer 222 can be fed into GPU pipeline again as vertex buffers 208 for further rendering. This stream output operation is an important step to recirculate data back into GPU pipeline 200.

In the next stage in GPU pipeline 200, output pixels from rasterizer 218 are processed by pixel shader 224, which performs various pixel operations, such as coloring a given pixel based on predetermined shading or lighting models. Note that pixel shader 224 can fetch texture information from texture buffer 226 and can add these textures to the pixels. In one embodiment, texture buffers 214, 216 and 226 are merged into a single texture buffer.

After passing through pixel shader 224, a merger output mechanism 228 can merge various types of output data, such as pixel shader outputs from pixel shader 224, and color and depth information (i.e., z-values) previously rendered at the same pixel locations from depth buffer 230, and color buffer 231. Note that color buffer 231 is sometimes referred to as render targets.

Embodiments of the disclosure can use some or all of the functional modules in GPU pipeline 200 to perform geometry LOD based dynamic object rendering. In some embodiments, the geometry LOD based rendering process comprises a number of stages, which include a preprocessing stage, an LOD computation stage, and a rendering stage. We described each of these stages in more detail below. Note that other variations of GPU pipeline 200 can also be used during the geometry-LOD-based dynamic-object rendering process.

### Preprocessing Stage

In some embodiments, prior to performing a rendering operation on an input object, a geometry mesh associated with the input object is preprocessed in a preprocessing stage to build an LOD based multi-resolution representation for the object. One purpose of the preprocessing stage is to build a regular LOD based multi-resolution representation of the input mesh so that it can be stored and accessed as a regular two-dimensional (2D) grid in the GPU memory. Note that many techniques for generating a multi-resolution representation for an input mesh can be used in the preprocessing stage to build the LOD based multi-resolution representation. Once built, the LOD based multi-resolution representation can be stored in the main memory, and can be subsequently accessed by the GPU during the LOD computation and rendering processes.

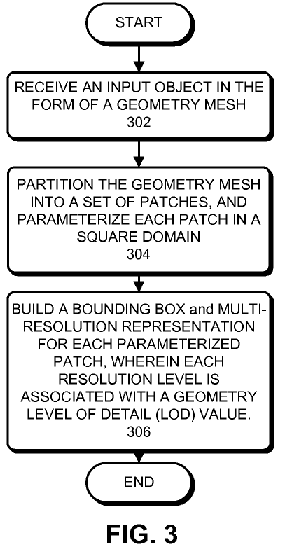

FIG. 3 presents a flowchart illustrating an offline process that builds an LOD based multi-resolution representation for an input object prior to performing a dynamic-rendering operation at real time on the object.

During operation, the system receives the input object in the form of a geometry mesh (step 302). Note that conventional mesh-generation techniques can be used to create the geometry mesh for the object. In some embodiments, the geometry mesh is a triangular mesh. In some embodiments, the geometry mesh can include a non-triangular mesh. In some embodiments, the geometry mesh is a deformable mesh.

The input geometry mesh is then partitioned into a set of disk-like patches (step 304), onto which the geometry is parameterized and sampled (see detail in “Geometry Images,” X. Gu, S. J. Gortler, H. Hoppe, ACM Siggraph 2002). Note that various mesh-partition techniques can be used, and hence the partition of the input mesh can yield different set of patches. In some embodiments, maximizing the reduction of geometry distortion is used as the mesh partition criterion. While in other embodiments, the coherency and connectivity of the partition datasets is used as the mesh partition criterion to get the optimal data processing performance from the real time hardware rendering system. In some embodiments, the input geometry is partitioned into multiple irregular geometry distortion pieces, each re-tessellated with a regular triangle mesh and packed into a single atlas in a multi-chart geometry image representation (more detail in “Multi-chart geometry images,” by P. Sander, Z. Wood, S. Gortler, J. Snyder, H. Hoppe, in Symposium on Geometry Processing 2003, pp. 146-155).

In some embodiments, partitioning the geometry mesh can be accomplished by creating hierarchical multi-chart (MC) geometry images for the mesh. In this embodiment, an MC geometry image for the mesh is a rectangular 2D grid whose entries store 3D coordinates sampled from a given surface. The process of generating MC geometry images from an input geometry mesh is described in more detail in “Multi-chart geometry images,” by P. Sander, Z. Wood, S. Gortler, J. Snyder and H. Hoppe, in ACM Symposium on Geometry Processing 2003.

After the input mesh has been partitioned into a set of parameterized patches, the system next builds a multi-resolution representation for each parameterized patch (step 306). Note that each resolution level in the multi-resolution representation is a geometry image characterized by a geometry level-of-detail (LOD) value. For example, the original parameterized patches comprising the original input mesh have the highest resolution level and hence a lowest LOD value. We designate this LOD value as “0,” or LOD=0. Accordingly, lower resolution level geometry images with LOD values=l(l>0) can be recursively generated by recursively down-sampling a higher resolution mesh of LOD value=l−1. (In a further embodiment, the resolution levels in a multi-resolution representation can be designated such that a higher resolution level is associated with a higher LOD value.) Note that a reduced resolution level is a result of reduced number of triangles inside a down-sampled geometry image. Also note that down-sampling of a patch can be performed using a conventional down-sampling filter or a user specific filter.

In one embodiment, each geometry image of the multi-resolution representation of a patch is associated with a three-dimensional (3D) bounding box representing the geometry boundary of the geometry image. Note that at the end of the preprocessing stage, the input object is represented by a collection of multi-patch, multi-resolution geometry images. In some embodiments, the multi-patch multi-resolution geometry images, along with the bounding box information, are stored in either a system memory or a graphics memory. In some embodiments, the vertex data of the bounding boxes are stored in vertex buffer 208, and the connectivity information of the vertices is stored in index buffer 206 within graphics memory 202.

Recall that one motivation for creating an LOD representation for an object is that objects at far distance may be displayed or rendered at a lower resolution than objects that are closer. Also note that the preprocessing of LOD based multi-resolution geometry representation can be performed off-line with or without using the GPU.

### Computing Real-Time LOD Values While Deforming the Object

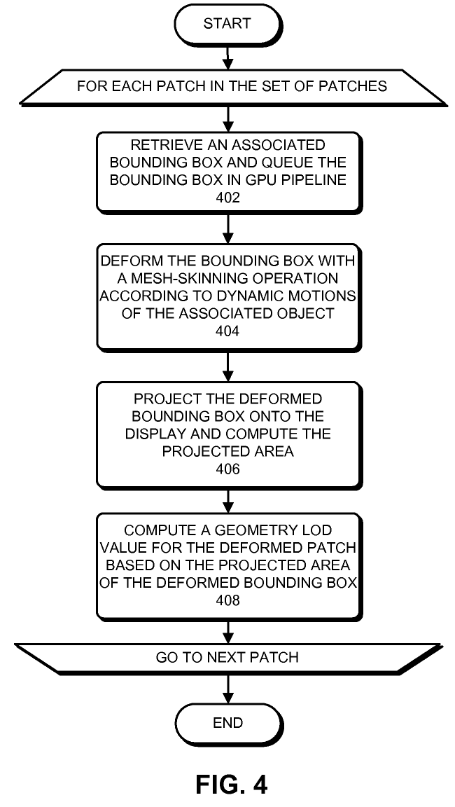

FIG. 4 presents a flowchart illustrating the process of computing real-time LOD values for a dynamic object when the object is being deformed.

During operation, for each patch generated during the preprocessing stage, the associated bounding box is retrieved from main memory and queued into the GPU pipeline (step 402). In one embodiment, each bounding box can be characterized by a set of vertices. Hence, retrieving the bounding box information involves retrieving the set of vertices associated the bounding box. Note that each retrieved vertex can be associated with many different attributes. In some embodiments, each vertex is at least characterized by its location in a 3D display environment according to the x-, y-, and z-coordinates. Note that each vertex may also be associated with colors, textures, and lighting characteristics.

The retrieved bounding box is then deformed by a mesh-skinning operation according to the dynamic motions of the associated object at each rendering frame (step 404). In some embodiments, the mesh-skinning operation is represented by a set of deformation matrices Mᵢ (i=0, . . . , N) and a set of predetermined weight parameters wᵢ (i=0, . . . , N). Hence, the mesh-skinning operation can be expressed as

$${\sum }_{i = 0}^{N} {w}_{i} {M}_{i} .$$

Note that the matrix elements for each deformation matrix Mᵢ can change dynamically according the object's motion. In these embodiments, deforming a retrieved bounding box involves applying the set of weighted deformation matrices to each vertex of the bounding box to obtain a set of modified vertices. Note that the set of modified vertices form a deformed bounding box representing the deformed patch according to the deformation matrix.

Next, each deformed bounding box is projected onto the display so that the projected area can be computed (step 406). The system next computes a geometry LOD value for the deformed patch based on the projected area of the deformed bounding box (step 408). In one embodiment, the system applies a geometry LOD function on the projected area of the deformed bounding box. In one embodiment, the LOD function is a monotonically increasing function of the projected area. In this embodiment, the LOD function can be a log-based function. For example, geometry LOD value can be computed from equation:

LOD=k log₂(aₚᵣₒⱼ), Eq. 1

wherein Aₚᵣₒⱼ represents the projected area of the deformed bounding box, and k is a positive constant. In one embodiment, the Aₚᵣₒⱼ can be measured in pixels. In one embodiment, k can be ½. In this embodiment, a projected area covering 4 pixels will produce a geometry LOD value of 1. However, in most cases, the computed geometry LOD value is a number comprising an integer part LODᵢ and a fractional part LOD_{f}. For example, an LOD value of 3.3 is comprised of integer part 3 and fractional part 0.3.

Note that although the above geometry LOD calculation is described in terms of a projected area of the deformed bounding box, the present embodiments are not meant to be limited to using a projected-area-based technique. In one embodiment, the geometry LOD value can be computed based on the distance between the object and the 3D projection center. In this embodiment, no screen projection is preformed. In some other embodiments, even with the projected area metric, the geometry LOD calculation can be performed without using the bounding box information. In one embodiment, a low-resolution representation of a dynamic object can be used to compute the geometry LOD instead of using an associated bounding box. For example, one can use the lowest resolution geometry representation of each patch generated during the preprocessing stage to compute the geometry LOD values during a dynamic deformation process.

In one embodiment, for each computed LOD value of a deformed patch, the system builds an LOD data structure for each vertex in the deformed bounding box. In one embodiment, the LOD data structure can include at least three pieces of information: an LOD value; a vertex buffer address, and an index buffer address. More specifically, the LOD value is the real-time LOD value computed for the deformed bounding box that the vertex is associated with. The vertex buffer address includes the memory locations of two vertices corresponding to two adjacent LOD levels in the vertex buffer. (This is explained in more detail below.) The index-buffer address includes the memory location of the geometry associated connectivity information in the index buffer. Note that an LOD data structure can also be built for each input patch. Also, the LOD value can be a real-time LOD value computed for the deformed patch at each frame. Moreover, the vertex buffer address can include the locations of vertices from two adjacent levels described by LODᵢ and LODᵢ₊₁ values within the precomputed multi-resolution representation of the patch in the vertex buffer. The index buffer address can also include the locations of the associated connectivity information in the index buffer.

Note that while the LOD values are being computed patch-by-patch for the input object, the system streams out a list of computed LOD data structures (referred to as an “LOD list”) and stores the LOD list in a buffer in GPU memory. In one embodiment, the system can use stream output 220 during this streaming process, and can store the LOD list in stream buffer 222. In a further embodiment, the system can store the LOD list in a dedicated LOD buffer 234 as illustrated in FIG. 2.

Note that while the LOD values are being computed patch-by-patch for the input object, the order and organization of the underneath geometry dataset is flexible. In some embodiments, each patch of objects can be dynamically and hierarchically partitioned into multiple rectangular tiles, and the LOD values and LOD list are generated from these tiles. In some embodiments, the connectivity of the vertices describing the geometry can be explicit or implied.

In one embodiment, the above-described LOD computation can be performed by a geometry shader program 210 using a shading language, which can include, but is not limited to a High Level Shading Language (HLSL).

### Rendering the Object

In some embodiments, the LOD list computed during the LOD computing process is used in a runtime rendering stage to draw appropriate geometries.

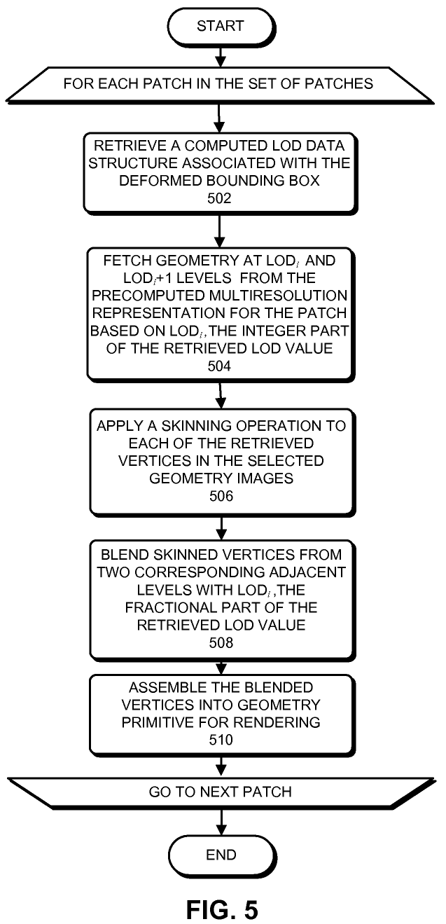

FIG. 5 presents a flowchart illustrating the process of rendering a dynamic object based on the computed LOD values. During operation, for each patch of the input object, the system retrieves a computed LOD data structure associated with the deformed bounding box (step 502). For example, the LOD data structure can be retrieved from LOD buffer 234. The system then uses the integer part i of the retrieved LOD value to select two pairs of vertex and index sets at adjacent levels LOD=i and LOD=i+1 from the precomputed multi-resolution geometry image representation for the patch stored in the main memory (i.e., prior to deforming operation) (step 504). More specifically, the system fetches the corresponding geometry data from the vertex and index buffers in the graphics memory based on the two LOD levels. Note that the system uses the address data in the LOD data structure to locate the appropriate data in the vertex and index buffers. This includes using the vertex buffer address to locate vertex data for each of the two LOD levels of the patch and the index buffer address to locate the connectivity for these vertices.

Next, the system applies a substantially identical skinning operation to each of the retrieved vertices (step 506). Specifically, denote the vertex being skinned as V and the corresponding vertices in the two retrieved LOD levels as Vᵢ for LOD=i and Vᵢ₊₁ for LOD=i+1, respectively. The system applies substantially identical deformation matrices that represent the dynamics of the object geometry to both Vᵢ and Vᵢ₊₁ to obtain modified vertices Vᵢ′ and Vᵢ₊₁′.

The system then renders the skinned vertex by blending the corresponding modified vertices Vᵢ′ and Vᵢ₊₁′ according to the fractional part of the LOD value, LOD_{f}(step 508). In one embodiment, the deformed vertex value V′ can be computed using the blending function as:

V′=blend(Vᵢ′, Vᵢ₊₁′, LOD_{f}). Eqn. 2

In one embodiment, Eqn. 2 can be computed as

V′=Vᵢ′×(1−LOD_{f})+Vᵢ₊₁′×LOD_{f}.

For example, if the precomputed LOD value is 3.3, then each deformed vertex in the associated bounding box is obtained by computing:

V′=0.7×(V₃)′+0.3×(V₄)′.

Note that other forms of the blending function can be used. In one embodiment, the blending operation for each vertex is computed by vertex shader 210. Next, the system assembles the modified vertices to form triangles (step 510).

### Hardware Implementation of the Rendering Process

During the runtime rendering stage, the GPU draws the appropriate geometry based on the LOD levels obtained from the LOD calculation stage. Ideally, the GPU can be configured to directly use the results in LOD buffer 234 in graphics memory 202 and can use the geometry referred by the vertex and index addresses in the LOD buffer in the GPU pipeline in a subsequent rendering operation to generate objects at the right level of detail for display. In other words, a GPU internal draw function can be called directly based on the flag bits in LOD buffer 234 (i.e., when new data becomes available in the LOD buffer). This scenario is illustrated in FIG. 2 with the connectors between LOD buffer 234 and index buffer 206 and vertex buffer 208 without CPU being involved. However, an existing graphics hardware/graphics API does not offer this operation directly. Hence, in practice, two alternative implementations are provided to perform the rendering operation.

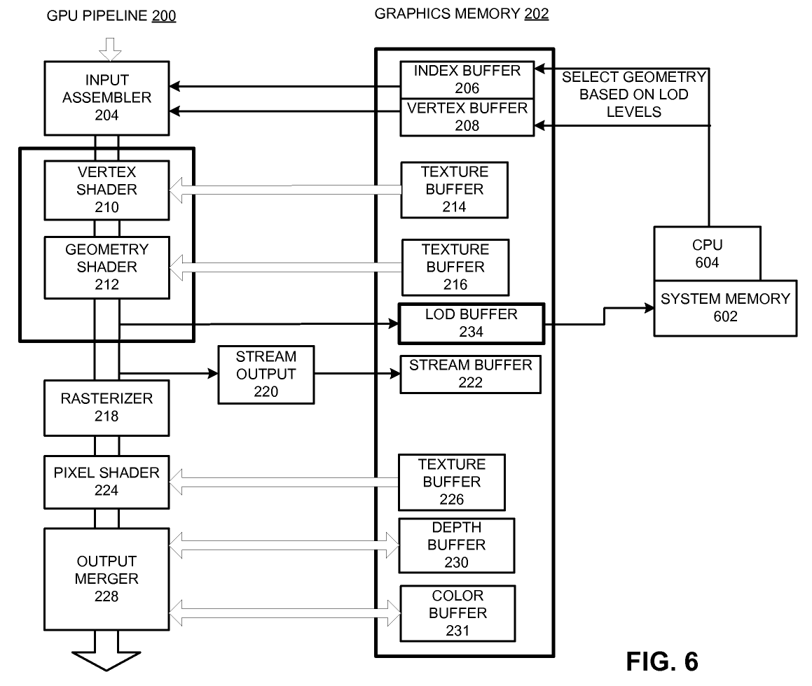

The first alternative is to let CPU 604 involved in the LOD-based rendering operation (see FIG. 6). In this embodiment, the LOD buffer contents are first copied to system memory 602 accessible by CPU 604. A corresponding Direct3D drawing call is then issued by CPU 604 based on the computed LOD results now located in system memory 602. Note that this approach has a performance penalty due to the latency of data transfer from graphics memory 202 to system memory 602 and to CPU 604. However, because the size of LOD buffer 234 is relatively small, this latency does not add significant overhead to the overall rendering operation.

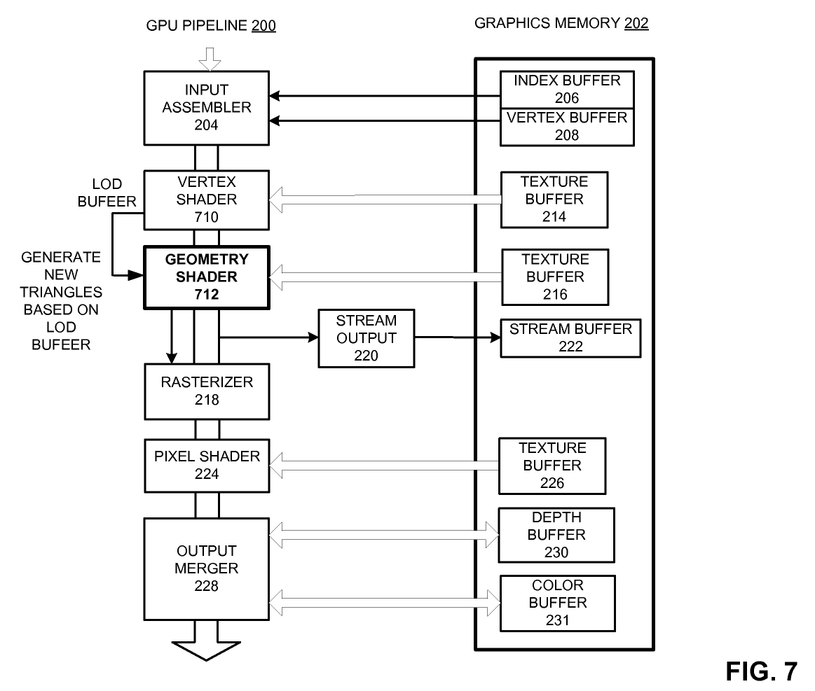

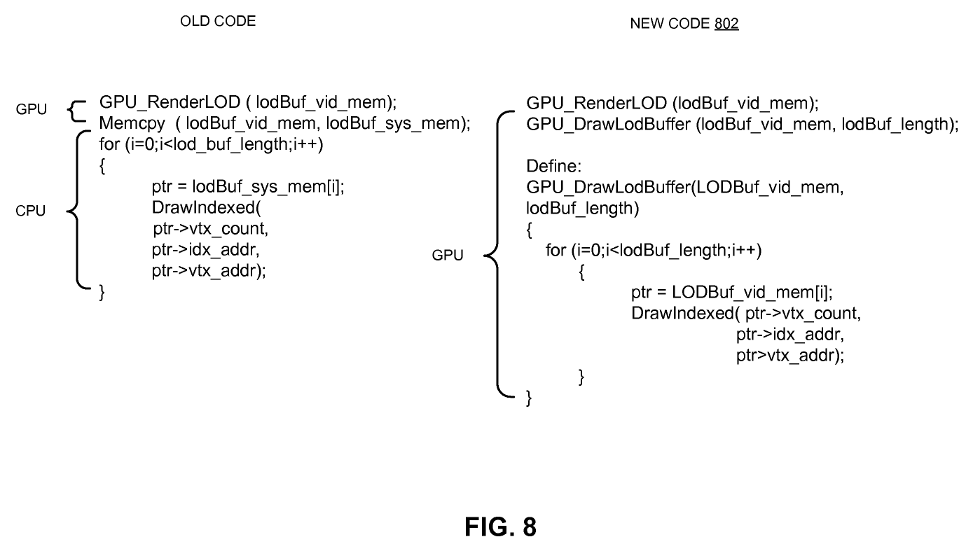

The second alternative utilizes the features of the geometry shader in a DirectX 10 pipeline (see FIG. 7). Note that unlike a conventional vertex shader, which can only pass and modify the properties of input vertex data, geometry shader 712 in FIG. 7 can either add the new geometry data into the pipeline or can reduce the input geometry on-the-fly. Hence, in this embodiment, geometry shader 712 is used to create the geometries at the appropriate level-of-detail on-the-fly. More specifically, shader code (see FIG. 8, the “new code 802”) is incorporated into geometry shader 212 to generate new triangles and their corresponding positions based on selected LOD levels computed in the LOD pass by either vertex shader 710 or geometry shader 712. Note that the performance of this technique depends highly on the actual performance and effectiveness of the geometry shader hardware.

### SUMMARY

Hence, this disclosure has described embodiments of a system that graphically renders an object. This system operates first by pre-processing a geometry mesh for the object offline, wherein the geometry mesh is partitioned into a set of patches, and wherein each patch is bounded by a bounding box. The system then builds a multi-resolution representation for each of the set of patches. Next, during real time rendering, the system deforms the bounding boxes associated with the set of patches through superposition of object motions in each frame weighted by a set of predetermined mesh-skinning parameters. For each deformed bounding box, the system computes a geometry level-of-detail (LOD) value based on a projected area of the deformed bounding box in screen space. The system next deforms the object through a set of mesh skinning operations. The system then renders the deformed object based on the computed geometry LOD values for the set of patches and the multi-resolution representation for the geometry mesh.

In some embodiments, the system builds the multi-resolution representation for each of the set of patches by building multiple resolution levels of geometry images for each patch.

In some embodiments, the system builds the multiple resolution levels of geometry images for each patch by forming a high-resolution geometry image with geometry LOD=0 based on the geometry mesh associated with the patch, and then recursively creating lower resolution levels of geometry images with geometry LOD=l(l>0) by recursively down-sampling the high-resolution geometry image.

In some embodiments, each patch has a quadrilateral boundary.

In some embodiments, the system deforms a bounding box by skinning a set of vertices associated with the bounding box.

In some embodiments, the system skins the set of vertices by applying a set of weighted deformation matrices to each vertex to obtain a set of modified vertices. More specifically, the set of weighted deformation matrices are constructed by a set of deformation parameters and a set of matrices describing the motions of different parts of objects. Hence, the set of modified vertices form a deformed bounding box.

In some embodiments, the system computes the geometry LOD value for each deformed bounding box by computing a projected area of the deformed bounding box on the display (in screen space) and computing geometry LOD value based on the projected area.

In some embodiments, the system computes the geometry LOD value based on the projected area by applying a geometry LOD function to the projected area, wherein the LOD function is a monotonically increasing function of the projected area.

In some embodiments, each geometry LOD value is a number comprising an integer part LODᵢ and a fractional part LOD_{f}.

In some embodiments, the system renders the deformed object by using the integer LODᵢ to fetch geometry images of geometry LOD=LODᵢ and geometry LOD=LODᵢ₊₁; and blending the vertex data associated with the fetched geometry images based on the fracture value LOD_{f}.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A method for rendering an object, comprising:
receiving a geometry mesh for the object, wherein the geometry mesh is partitioned into a set of patches, wherein each patch is bounded by a bounding box;
building a multi-resolution representation for each patch in the set of patches;
deforming the bounding boxes associated with the set of patches including applying a set of deformation matrices to a set of vertices associated with each bounding box;
for each deformed bounding box, computing a geometry level-of-detail (LOD) value based on a projected area of the deformed bounding box on a screen space;
deforming the object, including applying the set of deformation matrices to a set of vertices associated with the set of patches which comprise the object; and
rendering the deformed object based on the computed geometry LOD values for the set of patches and the multi-resolution representation for the geometry mesh.

2. The method of claim 1, wherein building the multi-resolution representation for each of the set of patches includes building multiple resolution levels of geometry images for each patch.

3. The method of claim 2, wherein building the multiple resolution levels of geometry images for each patch includes:
forming a high-resolution geometry image with geometry LOD=0 based on the geometry mesh associated with the patch; and
recursively creating lower resolution levels of geometry images with geometry LOD=l(l>0) including recursively down-sampling the high-resolution geometry image.

4. The method of claim 1, where each patch has a quadrilateral boundary.

5. The method of claim 1, wherein deforming a bounding box includes applying a set of weighted deformation matrices to each vertex associated with the bounding box to obtain a set of modified vertices for the bounding box.

6. The method of claim 5,
wherein the set of weighted deformation matrices are constructed based on a set of deformation parameters and a set of matrices describing the motions of different parts of objects; and
wherein the set of modified vertices form a deformed bounding box.

7. The method of claim 6, wherein computing the geometry LOD value for each deformed bounding box includes:
computing a projected area of the deformed bounding box on the display; and
computing an geometry LOD value based on the projected area.

8. The method of claim 7, wherein computing the geometry LOD value based on the projected area includes applying a geometry LOD function to the projected area, wherein the LOD function is a monotonically increasing function of the projected area.

9. The method of claim 7, wherein each geometry LOD value is a number comprising an integer part LODI and a fractional part LOD_{f}.

10. The method of claim 9, wherein rendering the deformed object based on the computed geometry LOD values and the multi-resolution representation for the geometry mesh includes:
using the integer i to fetch geometry images of geometry LOD=LODᵢ and geometry LOD=LODᵢ₊₁; and
blending the vertex data associated with the fetched geometry images based on the fracture value LOD_{f}.

11. A computer-readable storage medium storing instructions that when executed by a computer cause the computer to perform a method for rendering an object, the method comprising:
receiving a geometry mesh for the object, wherein the geometry mesh is partitioned into a set of patches, wherein each patch is bounded by a bounding box;
building a multi-resolution representation for each patch in the set of patches;
deforming the bounding boxes associated with the set of patches including applying a set of deformation matrices to a set of vertices associated with each bounding box;
for each deformed bounding box, computing a geometry level-of-detail (LOD) value based on a projected area of the deformed bounding box on a screen space;
deforming the object including applying the set of deformation matrices to a set of vertices associated with the set of patches which comprise the object; and
rendering the deformed object based on the computed geometry LOD values for the set of patches and the multi-resolution representation for the geometry mesh.

12. The computer-readable storage medium of claim 11, wherein building the multi-resolution representation for each of the set of patches includes building multiple resolution levels of geometry images for each patch.

13. The computer-readable storage medium of claim 12, wherein building the multiple resolution levels of geometry images for each patch includes:
forming a high-resolution geometry image with geometry LOD=0 based on the geometry mesh associated with the patch; and
recursively creating lower resolution levels of geometry images with geometry LOD=l(l>0) including recursively down-sampling the high-resolution geometry image.

14. The computer-readable storage medium of claim 11, wherein deforming a bounding box includes applying a set of weighted deformation matrices to each vertex associated with the bounding box to obtain a set of modified vertices for the bounding box.

15. The computer-readable storage medium of claim 14,
wherein the set of weighted deformation matrices are constructed based on a set of deformation parameters and a set of matrices describing the motions of different parts of objects; and
wherein the set of modified vertices form a deformed bounding box.

16. The computer-readable storage medium of claim 15, wherein computing the geometry LOD value for each deformed bounding box includes:
computing a projected area of the deformed bounding box on the display; and
computing an geometry LOD value based on the projected area.

17. The computer-readable storage medium of claim 16, wherein computing the geometry LOD value based on the projected area includes applying a geometry LOD function to the projected area, wherein the LOD function is a monotonically increasing function of the projected area.

18. The computer-readable storage medium of claim 16, wherein each geometry LOD value is a number comprising an integer part LODᵢ and a fractional part LOD_{f}.

19. The computer-readable storage medium of claim 18, wherein rendering the deformed object based on the computed geometry LOD values and the multi-resolution representation for the geometry mesh includes:
using the integer i to fetch geometry images of geometry LOD=LODᵢ and geometry LOD=LODᵢ₊₁; and
blending the vertex data associated with the fetched geometry images based on the fracture value LOD_{f}.

20. A graphics processing unit (GPU) that renders an object, comprising:
a receiving mechanism configured to receive:
a geometry mesh for the object, wherein the geometry mesh is partitioned into a set of patches, wherein each patch is bounded by a bounding box; and
a multi-resolution representation for each patch in the set of patches;
a graphics memory comprising an index buffer and a vertex buffer, wherein the index buffer and the vertex buffer are configured to store the multi-resolution representation;
a first shader program programmed to deform the bounding boxes associated with the set of patches including applying a set of deformation matrices to a set of vertices associated with each bounding box;
a second shader program programmed to compute a geometry level-of-detail (LOD) value for each deformed bounding box based on a projected area of the deformed bounding box on a screen space; and
a rendering mechanism configured to render the object based on the computed geometry LOD values for the set of patches and the multi-resolution representation for the geometry mesh.

21. The GPU of claim 20, wherein the graphics memory further comprises a LOD buffer configured to store the computed geometry LOD values.

22. An apparatus, comprising:
a means for receiving a geometry mesh for an object, wherein the geometry mesh is partitioned into a set of patches, wherein each patch is bounded by a bounding box;
a means for building a multi-resolution representation for each patch in the set of patches;
a means for deforming the bounding boxes associated with the set of patches including applying a set of deformation matrices to a set of vertices associated with each bounding box;
an LOD means for computing a geometry level-of-detail (LOD) value for each deformed bounding box based on a projected area of the deformed bounding box on a screen space;
a means for deforming the object including applying the set of deformation matrices to a set of vertices associated with the set of patches which comprise the object; and
a means for rendering the deformed object based on the computed geometry LOD values for the set of patches and the multi-resolution representation for the geometry mesh.
